(19) United States
(12) Patent Application Publication
(10) Pub. No.: US 2026/0319317 A1
(43) Pub. Date: Oct. 15, 2026

(54) ELECTRONIC PAPER DISPLAY DEVICE

(71) Applicant: E Ink Holdings Inc., Hsinchu (TW)

(72) Inventors: Yi Jiun Wu, Hsinchu (TW); Chee Yun Low, Hsinchu (TW); Wen-Chung Tang, Hsinchu (TW); Kuo-Hsing Cheng, Hsinchu (TW); Chi Meng Wu, Hsinchu (TW); Sheng-Long Lin, Hsinchu (TW); Chen Yun Ma, Hsinchu (TW); Ting-Yung Lai, Hsinchu (TW); Chin Tsung Liang, Hsinchu (TW)

(73) Assignee: E Ink Holdings Inc., Hsinchu (TW)

(21) Appl. No.: 19/634,122

(22) Filed: Mar. 31, 2026

(30) Foreign Application Priority Data
Apr. 9, 2025 (TW) 114113323

(51) Int. Cl. G02F 1/16753; G02F 1/167

(52) U.S. Cl. CPC G02F 1/16753; G02F 1/167

(57) ABSTRACT

An electronic paper (E-paper) display device includes an E-paper supporting structure, an E-paper display layer, and an edge conductive pattern. The E-paper supporting structure has a display surface, a bonding surface opposite to the display surface, and a side connection surface connected between the display surface and the bonding surface, in which the E-paper supporting structure includes a display surface pad exposed on the display surface and a bonding surface pad exposed on the bonding surface. The E-paper display layer is disposed on the display surface of the E-paper supporting structure. The edge conductive pattern physically contacts the E-paper supporting structure. The edge conductive pattern physically contacts the side connection surface and continuously extends on the side connection surface between the display surface and the bonding surface to contact the display surface pad and the bonding surface pad.

### CROSS-REFERENCE TO RELATED APPLICATION

This application claims the priority benefit of Taiwan application serial no. 114113323, filed on Apr. 9, 2025. The entirety of the above-mentioned patent application is hereby incorporated by reference herein and made a part of this specification.

### BACKGROUND

### Technical Field

The disclosure relates to an electronic device, and particularly relates to an electronic paper display device.

### Related Art

In the electronic paper display device, the driving circuit chip is usually bonded to the display panel through Chip on Glass (COG) or Chip on Film (COF) method, and at the same time, a flexible circuit board is configured to be connected to the external system. Reducing the frame width is one of the research and development directions for various display devices, but the above methods cannot meet the requirements of narrow frames. Therefore, there is still room for improvement in the electronic paper display device.

### SUMMARY

The disclosure provides an electronic paper display device, which may have a narrow frame structure.

The electronic paper display device of the disclosure includes an electronic paper supporting structure, an electronic paper display layer, and an edge conductive pattern. The electronic paper supporting structure has a display surface, a bonding surface, and a side connection surface. The display surface and the bonding surface are opposite to each other, and the side connection surface is connected between the display surface and the bonding surface, in which the electronic paper supporting structure includes a display surface pad exposed on the display surface and a bonding surface pad exposed on the bonding surface. The electronic paper display layer is disposed on the display surface of the electronic paper supporting structure. The edge conductive pattern physically contacts the electronic paper supporting structure. The edge conductive pattern physically contacts the side connection surface and continuously extends on the side connection surface between the display surface and the bonding surface to contact the display surface pad and the bonding surface pad.

In an embodiment of the disclosure, the edge conductive pattern includes a first portion, a second portion, and a third portion. The first portion is disposed on the display surface, the second portion is disposed on the bonding surface, and the third portion is disposed on the side connection surface. The first portion and the second portion extend in the same direction from the third portion in the lateral direction. The first portion and the second portion extend in opposite directions from the third portion in the lateral direction.

In an embodiment of the disclosure, the electronic paper display device further includes an edge isolation pattern and another edge conductive pattern. The edge isolation pattern covers the edge conductive pattern, and the another edge conductive pattern is disposed on the edge isolation pattern. The edge conductive pattern and the another edge conductive pattern are alternately disposed along an extension direction of the side connection surface of the electronic paper supporting structure. The edge conductive pattern, the edge isolation pattern, and the another edge conductive pattern are continuously disposed conforming to the display surface, the side connection surface, and the bonding surface respectively. The electronic paper supporting structure further includes another display surface pad exposed on the display surface, and the another edge conductive pattern contacts the another display surface pad. A lateral distance between the display surface pad and the side connection surface is smaller than a lateral distance between the another display surface pad and the side connection surface. The electronic paper supporting structure further includes another bonding surface pad exposed on the bonding surface, and the another edge conductive pattern contacts the another bonding surface pad. A lateral distance between the bonding surface pad and the side connection surface is smaller than a lateral distance between the another bonding surface pad and the side connection surface.

In an embodiment of the disclosure, the electronic paper supporting structure includes a pixel array substrate, and the pixel array substrate has a display surface and includes a display surface pad. The electronic paper supporting structure further includes a driving circuit carrier and an adhesive layer. The adhesive layer attaches the driving circuit carrier to the pixel array substrate, and the driving circuit carrier has a bonding surface and includes a bonding surface pad. The driving circuit carrier protrudes outward with respect to the pixel array substrate. The electronic paper display device further includes an enhanced substrate. The enhanced substrate is attached to the driving circuit carrier. The bonding surface faces the pixel array substrate. The side connection surface includes a side wall of the pixel array substrate, a side wall of the driving circuit carrier, and a side wall of the adhesive layer. The electronic paper supporting structure further includes an enhanced substrate and an adhesive layer. The enhanced substrate is attached to the pixel array substrate through the adhesive layer. The side connection surface includes a side wall of the pixel array substrate, a side wall of the enhanced substrate, and a side wall of the adhesive layer.

In an embodiment of the disclosure, the side connection surface of the electronic paper supporting structure includes a side edge section and two chamfer sections. The two chamfer sections respectively extend between the side edge section and the display surface and between the side edge section and the bonding surface, and the two chamfer sections are inclined with respect to the side edge section.

Based on the above, the electronic paper display device of the embodiments of the disclosure achieves electrical connection between different substrates or surfaces opposite to the substrate by the conductive patterns disposed on the side wall of the substrate, thereby realizing a narrow frame design.

### BRIEF DESCRIPTION OF THE DRAWINGS

FIG. 1 is a schematic diagram of a method for manufacturing an electronic paper display device according to an embodiment of the disclosure.

FIG. 2 is a schematic diagram of the electronic paper display device according to an embodiment of the disclosure.

FIG. 3 is a schematic diagram of the electronic paper display device according to an embodiment of the disclosure.

FIG. 4 is a schematic diagram of the electronic paper display device according to an embodiment of the disclosure.

FIG. 5 is a schematic diagram of the electronic paper display device according to an embodiment of the disclosure.

FIG. 6 is a schematic diagram of the electronic paper display device according to an embodiment of the disclosure.

FIG. 7 is a partial perspective view of the electronic paper display device in FIG. 6.

FIG. 8 is another embodiment of an electronic paper supporting structure in the electronic paper display device in FIG. 6.

### DESCRIPTION OF THE EMBODIMENTS

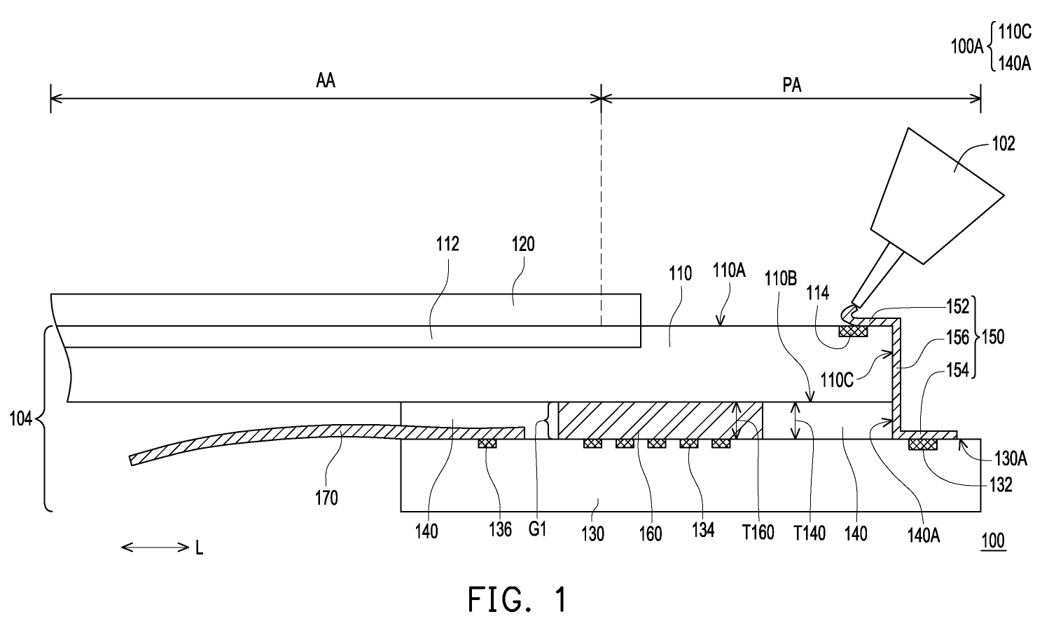

FIG. 1 is a schematic diagram of a method for manufacturing an electronic paper display device according to an embodiment of the disclosure. An electronic paper display device 100 in FIG. 1 includes at least a pixel array substrate 110, an electronic paper display layer 120, a driving circuit carrier 130, an adhesive layer 140, and an edge conductive pattern 150. The pixel array substrate 110 has a display surface 110A, a back surface 110B, and a side wall 110C, in which the display surface 110A and the back surface 110B are opposite to each other, and the side wall 110C is connected between the display surface 110A and the back surface 110B. The electronic paper display layer 120 is disposed on the display surface 110A of the pixel array substrate 110, while the driving circuit carrier 130 is disposed on the back surface 110B of the pixel array substrate 110. The adhesive layer 140 attaches the driving circuit carrier 130 to the back surface 110B of the pixel array substrate 110. The edge conductive pattern 150 physically contacts the pixel array substrate 110, the adhesive layer 140, and the driving circuit carrier 130. In addition, the electronic paper display device 100 further includes a driving circuit chip 160 bonded to the driving circuit carrier 130 and a connection circuit board 170, in which the connection circuit board 170 is configured to connect the electronic paper display device 100 to an external system, and the connection circuit board 170 is, for example, a printed circuit board.

The pixel array substrate 110 may be a substrate disposed with a pixel circuit array 112. For convenience of description, the specific structure of the pixel circuit array 112 is not individually presented in FIG. 1, but it may be understood that the pixel circuit array 112 includes, for example, multiple active components (such as thin film transistors), related circuit components (such as storage capacitors), and conductive lines (such as scan lines, data lines) corresponding to the active components and/or related circuit components. In addition, the pixel array substrate 110 may include a display surface pad 114 exposed on the display surface 110A. The display surface pad 114 may be integrated into at least one layer of conductive lines of the pixel circuit array 112, and disposed adjacent to the side wall 110C of the pixel array substrate 110. The side wall 110C of the pixel array substrate 110 may be connected between the display surface 110A and the back surface 110B, and extend along the thickness direction of the pixel array substrate 110. In some embodiments, the display surface pad 114 and the side wall 110C may be separated by a lateral distance in the lateral direction L. In this embodiment, "lateral" may be understood as the direction extending from the side wall 110C toward the electronic paper display layer 120.

In some embodiments, the electronic paper display layer 120 may optionally include multiple microcapsules and electronic ink filled within the microcapsules. In some embodiments, the electronic paper display layer 120 may optionally include multiple microcup structures and electronic ink filled within the microcup structures. The electronic paper display layer 120 may be an electrophoretic layer. In other embodiments, the electronic paper display layer 120 may be, for example, a quick response liquid powder layer, a cholesteric liquid crystal layer, or an electrowetting layer. The display medium in the electronic paper display layer 120 (such as the electrophoretic particles in the electronic ink) may present different arrangements or states under the driving of the pixel circuit array 112 to provide the required display effect.

In this embodiment, the driving circuit carrier 130 may be considered as a circuit board carrying the driving circuit chip 160. The driving circuit carrier 130 may be a substrate disposed with multiple signal transmission lines. For example, the driving circuit carrier 130 may include a supporting substrate and the signal transmission lines disposed on the supporting substrate. The driving circuit carrier 130 may further include bonding surface pad 132, pad 134, and pad 136 exposed on the bonding surface 130A. The bonding surface pad 132 is used for electrical connection with the display surface pad 114 of the pixel array substrate 110, the pad 134 is used for electrical connection with the driving circuit chip 160, and the pad 136 is used for electrical connection with the connection circuit board 170. In this embodiment, the driving circuit carrier 130 protrudes outward with respect to the pixel array substrate 110, and the bonding surface pad 132 is disposed on the protruding portion of the driving circuit carrier 130 and faces the pixel array substrate 110. That is, the bonding surface pad 132 is located in an area outside the pixel array substrate 110.

The bonding surface 130A of the driving circuit carrier 130 faces the pixel array substrate 110 and the adhesive layer 140, and the adhesive layer 140 attaches the driving circuit carrier 130 to the back surface 110B of the pixel array substrate 110. The adhesive layer 140 may be a double-sided tape. Additionally, the adhesive layer 140 may fill a gap G1 between the driving circuit carrier 130 and the pixel array substrate 110. The driving circuit chip 160 may be located between the driving circuit carrier 130 and the pixel array substrate 110, and a thickness T140 of the adhesive layer 140 may not be less than a thickness T160 of the driving circuit chip 160.

In this embodiment, the composite structure formed by the pixel array substrate 110, the driving circuit carrier 130, and the adhesive layer 140 may serve as the electronic paper supporting structure 104 for carrying the electronic paper display layer 120. The electronic paper supporting structure 104 has a display surface 110A, a bonding surface 130A, and a side connection surface 100A, and includes the display surface pad 114 exposed on the display surface 110A and the bonding surface pad 132 exposed on the bonding surface 130A. Additionally, the side wall 110C of the pixel array substrate 110 and the side wall 140A of the adhesive layer 140 may be connected to form the side connection surface 100A. The side wall 140A of the adhesive layer 140 may extend from the side wall 110C of the pixel array substrate 110 toward the driving circuit carrier 130 to reach the bonding surface 130A of the driving circuit carrier 130. In some embodiments, the side wall 110C of the pixel array substrate 110 and the side wall 140A of the adhesive layer 140 may be coplanar.

The edge conductive pattern 150 includes a first portion 152, a second portion 154, and a third portion 156. The first portion 152 is disposed on the display surface 110A of the pixel array substrate 110, and the first portion 152 may contact the display surface pad 114 of the pixel array substrate 110. The second portion 154 is disposed on the bonding surface 130A of the driving circuit carrier 130, and the second portion 154 may contact the bonding surface pad 132 of the driving circuit carrier 130. The third portion 156 is disposed on the side connection surface 100A and extends between the first portion 152 and the second portion 154. Furthermore, the first portion 152 and the second portion 154 of the edge conductive pattern 150 extend in opposite directions from the third portion 156 in a lateral direction L.

The third portion 156 of the edge conductive pattern 150 may contact the side wall 110C of the pixel array substrate 110 and the side wall 140A of the adhesive layer 140. The side wall 140A of the adhesive layer 140 and the side wall 110C of the pixel array substrate 110 may form a smooth side connection surface 100A that continuously extends from the display surface 110A of the pixel array substrate 110 to reach the bonding surface 130A of the driving circuit carrier 130. Therefore, the third portion 156 of the edge conductive pattern 150 may extend continuously and without easy breakage between the first portion 152 and the second portion 154.

In some embodiments, as shown in FIG. 1, the edge conductive pattern 150 may be manufactured by inkjet printing or coating method. For example, the manufacturing method of the edge conductive pattern 150 may use a nozzle 102 for inkjet printing or coating to spray conductive material on the bonding surface 130A of the driving circuit carrier 130, followed by spraying the conductive material on the side wall 110C of the pixel array substrate 110 and the side wall 140A of the adhesive layer 140 to form the third portion 156, and then spraying the conductive material on the display surface 110A of the pixel array substrate 110 to form the first portion 152. Alternatively, the conductive material may be inkjet printed or coated in the opposite direction. The edge conductive pattern 150 may directly contact the display surface 110A of the pixel array substrate 110 and directly contact the bonding surface 130A of the driving circuit carrier 130, thereby the edge conductive pattern 150 may electrically connect the bonding surface pad 132 of the driving circuit carrier 130 with the display surface pad 114 of the pixel array substrate 110. Additionally, the side wall 140A of the adhesive layer 140 and the side wall 110C of the pixel array substrate 110 may form a smooth side connection surface 100A that continuously extends from the display surface 110A of the pixel array substrate 110 to reach the bonding surface 130A of the driving circuit carrier 130, which helps ensure that during the process of spraying the conductive material, the conductive material does not break and/or cause significant thickness variation due to structural changes, thereby ensuring the continuity of the edge conductive pattern 150.

The edge conductive pattern 150 is directly printed or sprayed on the pixel array substrate 110, the adhesive layer 140, and the driving circuit carrier 130. Therefore, the electronic paper display device 100 does not need additional space for wire installation to achieve electrical connection between the pixel array substrate 110 and the driving circuit carrier 130, which helps streamline the overall volume of the electronic paper display device 100. For example, the electronic paper display layer 120 may have a display area AA with actual displayable screen. In some embodiments, since the edge conductive pattern 150 is directly printed or sprayed on the pixel array substrate 110, the adhesive layer 140, and the driving circuit carrier 130, in the lateral direction L, the width of a peripheral area PA extending outward from the display area AA to the edge of the overall device may be reduced, for example, to 1.9 mm (millimeters). Compared with existing designs, such as using wire-bond method to achieve electrical connection between the pixel array substrate 110 and the driving circuit carrier 130, the width of the peripheral area PA often reaches 2.4 mm (millimeters) or more. Additionally, the edge conductive pattern 150 adheres closely to the pixel array substrate 110, the adhesive layer 140, and the driving circuit carrier 130, so the edge conductive pattern 150 is not easily damaged during subsequent manufacturing, use, and other processes, and can stably maintain the electrical connection between the pixel array substrate 110 and the driving circuit carrier 130.

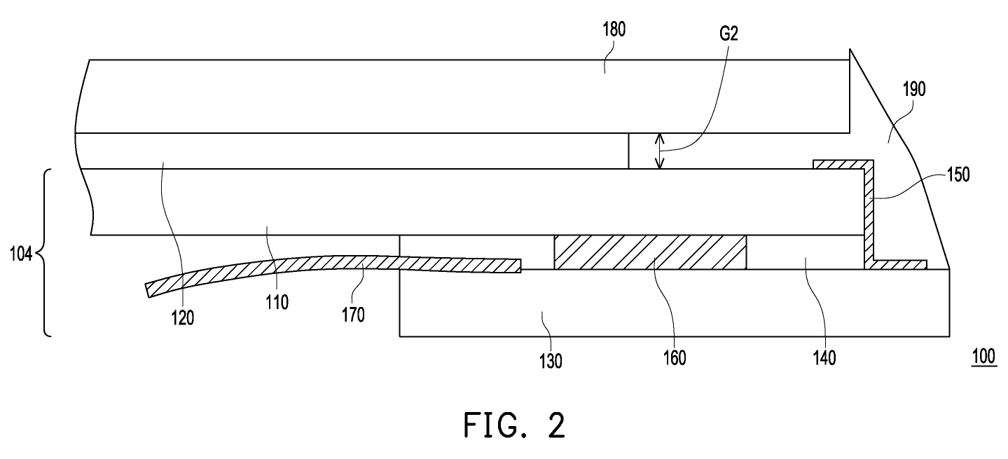

FIG. 2 is a schematic diagram of the electronic paper display device according to an embodiment of the disclosure. The electronic paper display device 100 in FIG. 2 is an encapsulated implementation of the electronic paper display device 100 in FIG. 1, and the same reference numerals in both figures may represent the same or equivalently replaceable components. Specifically, in addition to the electronic paper supporting structure 104 including the pixel array substrate 110, the driving circuit carrier 130, and the adhesive layer 140, the electronic paper display layer 120, the edge conductive pattern 150, the driving circuit chip 160, and the connection circuit board 170 already described in FIG. 1, the electronic paper display device 100 further includes a protective plate 180 and a sealing adhesive 190. The protective plate 180 may be attached to the electronic paper display layer 120, so that the electronic paper display layer 120 is sandwiched between the protective plate 180 and the pixel array substrate 110. The sealing adhesive 190 is disposed along the edge of the electronic paper display device 100, covering the electronic paper display layer 120 and the edge conductive pattern 150 exposed at the edge of the electronic paper display device 100. Additionally, the protective plate 180 and the pixel array substrate 110 may protrude with respect to the electronic paper display layer 120, and the sealing adhesive 190 may fill a gap G2 between the protective plate 180 and the pixel array substrate 110. The protective plate 180 and the sealing adhesive 190 may further protect the various components of the electronic paper display device 100 from damage due to invasion of external substances. In some embodiments, the sealing adhesive 190 may have moisture barrier properties, which may prevent damage to the electronic paper display layer 120 and the edge conductive pattern 150 due to invasion of moisture.

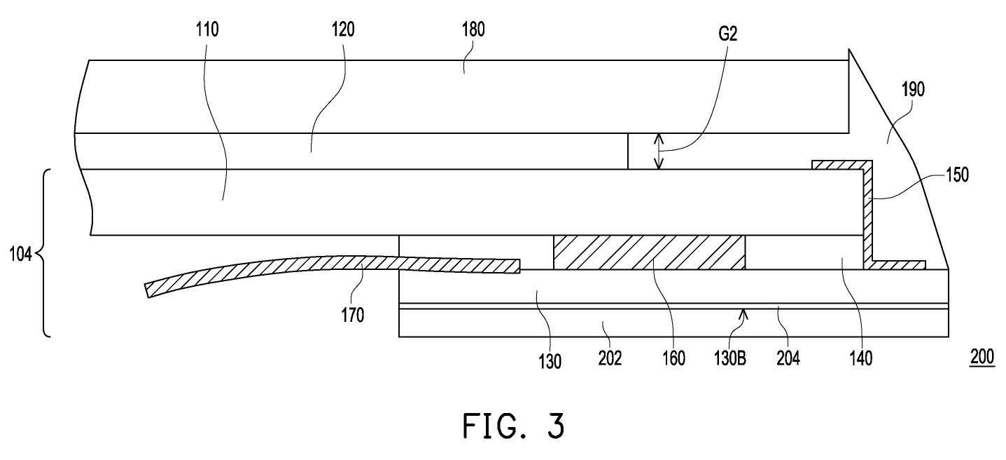

FIG. 3 is a schematic diagram of the electronic paper display device according to an embodiment of the disclosure. In an electronic paper display device 200 in FIG. 3 and the electronic paper display device 100 in FIG. 2, the same reference numerals may represent the same or equivalently replaceable components. In addition to the electronic paper supporting structure 104 including the pixel array substrate 110, the driving circuit carrier 130, and the adhesive layer 140, the electronic paper display layer 120, the edge conductive pattern 150, the driving circuit chip 160, the connection circuit board 170, the protective plate 180, and the sealing adhesive 190 already described in FIG. 2, the electronic paper display device 200 in FIG. 3 further includes an enhanced substrate 202 and an adhesive layer 204. The enhanced substrate 202 is disposed on the back surface 130B of the driving circuit carrier 130 and attached to the driving circuit carrier 130 through the adhesive layer 204. In some embodiments, the driving circuit carrier 130 may be a flexible circuit board, for example, using polyamide or polyimide film as the carrier body. Therefore, the driving circuit carrier 130 attached to the pixel array substrate 110 alone may have insufficient support or mechanical strength. In this embodiment, the disposition of the enhanced substrate 202 helps enhance the mechanical strength, so that the driving circuit carrier 130 may be attached to the pixel array substrate 110 in a good and stable condition. In some embodiments, when the driving circuit carrier 130 uses a carrier body with higher mechanical strength, such as glass or other plastic materials with higher mechanical strength, the enhanced substrate 202 may be omitted, resulting in the structure shown in FIG. 2.

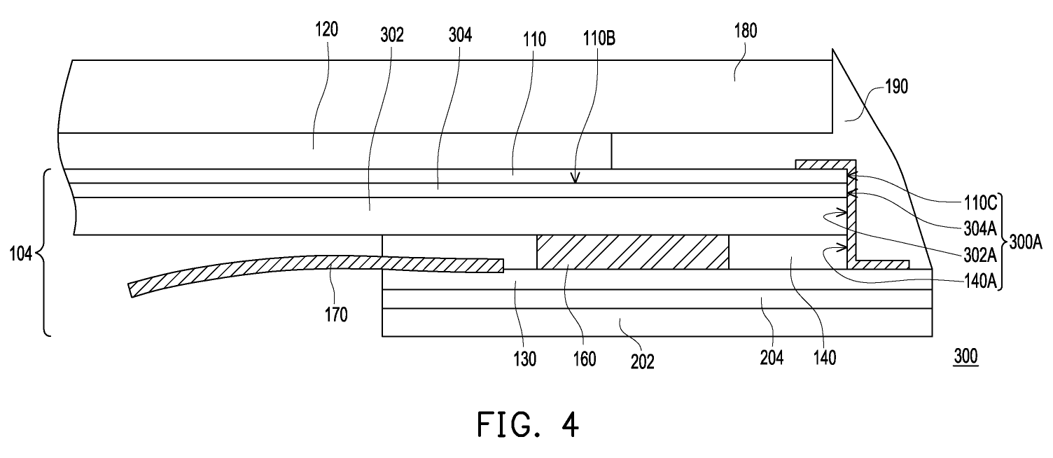

FIG. 4 is a schematic diagram of the electronic paper display device according to an embodiment of the disclosure. In an electronic paper display device 300 in FIG. 4 and the electronic paper display device 200 in FIG. 3, the same reference numerals may represent the same or equivalently replaceable components. In addition to the electronic paper supporting structure 104 including the pixel array substrate 110, the driving circuit carrier 130, and the adhesive layer 140, the electronic paper display layer 120, the edge conductive pattern 150, the driving circuit chip 160, the connection circuit board 170, the protective plate 180, the sealing adhesive 190, the enhanced substrate 202, and the adhesive layer 204 already described in FIG. 3, the electronic paper supporting structure 104 of this embodiment further includes an enhanced substrate 302 and an adhesive layer 304. The enhanced substrate 302 is disposed on the back surface 110B of the pixel array substrate 110 and attached to the pixel array substrate 110 through the adhesive layer 304. In some embodiments, the pixel array substrate 110 may, for example, use polyamide or polyimide film as the substrate body and have flexibility. Therefore, when the pixel array substrate 110 is disposed alone, it may have insufficient support or mechanical strength. In this embodiment, the disposition of the enhanced substrate 302 can increase the mechanical strength, so that the pixel array substrate 110 has good support. In some embodiments, when the pixel array substrate 110 uses a substrate body with higher mechanical strength, such as glass or other plastic materials with higher mechanical strength, the enhanced substrate 302 may be omitted, resulting in the structure shown in FIG. 2.

As shown in FIG. 4, the side wall 302A of the enhanced substrate 302 and the side wall 304A of the adhesive layer 304 both extend to approximately align with the pixel array substrate 110. As such, the side wall 110C of the pixel array substrate 110, the side wall 302A of the enhanced substrate 302, the side wall 304A of the adhesive layer 304, and the side wall 140A of the adhesive layer 140 may form a smooth side connection surface 300A. The side connection surface 300A is formed by the adjoining side walls of multiple components, but is generally smooth. Therefore, the edge conductive pattern 150 may continuously extend along the side connection surface 300A, forming a conductive path between the pixel array substrate 110 and the driving circuit carrier 130.

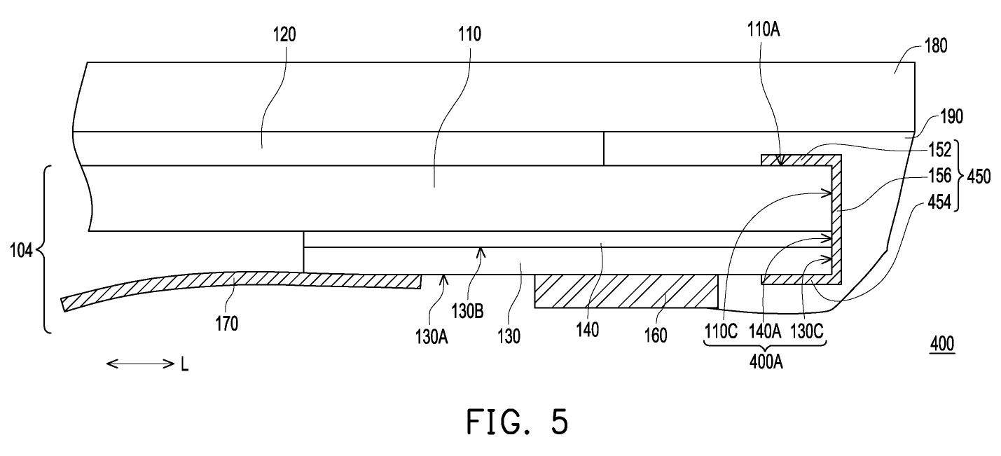

FIG. 5 is a schematic diagram of the electronic paper display device according to an embodiment of the disclosure. In an electronic paper display device 400 in FIG. 5 and the electronic paper display device 100 in FIG. 2, the same reference numerals may represent the same or equivalently replaceable components. The electronic paper display device 400 in FIG. 5 includes, for example, the electronic paper supporting structure 104 including the pixel array substrate 110, the driving circuit carrier 130, and the adhesive layer 140, the electronic paper display layer 120, the driving circuit chip 160, the connection circuit board 170, the protective plate 180, and the sealing adhesive 190 already described in FIG. 2. In addition, the electronic paper display device 400 further includes an edge conductive pattern 450, in which the edge conductive pattern 450 provides a function similar to the edge conductive pattern 150 in FIG. 2, but has a different structural design.

Specifically, in this embodiment, the positioning of the driving circuit carrier 130 is different from the embodiment in FIG. 2. The bonding surface 130A of the driving circuit carrier 130 is disposed to face away from the pixel array substrate 110 and the adhesive layer 140, and the back surface 130B of the driving circuit carrier 130 contacts the adhesive layer 140. Therefore, the driving circuit chip 160 is bonded to the bonding surface 130A of the driving circuit carrier 130, and the driving circuit carrier 130 is located between the driving circuit chip 160 and the adhesive layer 140. In this embodiment, in addition to the side wall 110C of the pixel array substrate 110 and the side wall 140A of the adhesive layer 140 which may be disposed to conform to each other, the side wall 130C of the driving circuit carrier 130 and the side wall 140A of the adhesive layer 140 are also disposed to conform to each other. The side wall 110C of the pixel array substrate 110, the side wall 140A of the adhesive layer 140, and the side wall 130C of the driving circuit carrier 130 may successively form a smooth side connection surface 400A.

The edge conductive pattern 450 includes a first portion 152, a second portion 454, and a third portion 156. The first portion 152 is disposed on the display surface 110A of the pixel array substrate 110, the second portion 454 is disposed on the bonding surface 130A of the driving circuit carrier 130, and the third portion 156 extends between the first portion 152 and the second portion 454. The third portion 156 of the edge conductive pattern 450 may contact the side wall 110C of the pixel array substrate 110, the side wall 140A of the adhesive layer 140, and the side wall 130C of the driving circuit carrier 130, and continuously extend on the side connection surface 400A. Furthermore, the first portion 152 and the second portion 454 of the edge conductive pattern 450 both extend in the same direction (for example, pointing toward the electronic paper display layer 120) from the third portion 156 in the lateral direction L, forming a structure that is shaped approximately similar to the letter "C" in the side view.

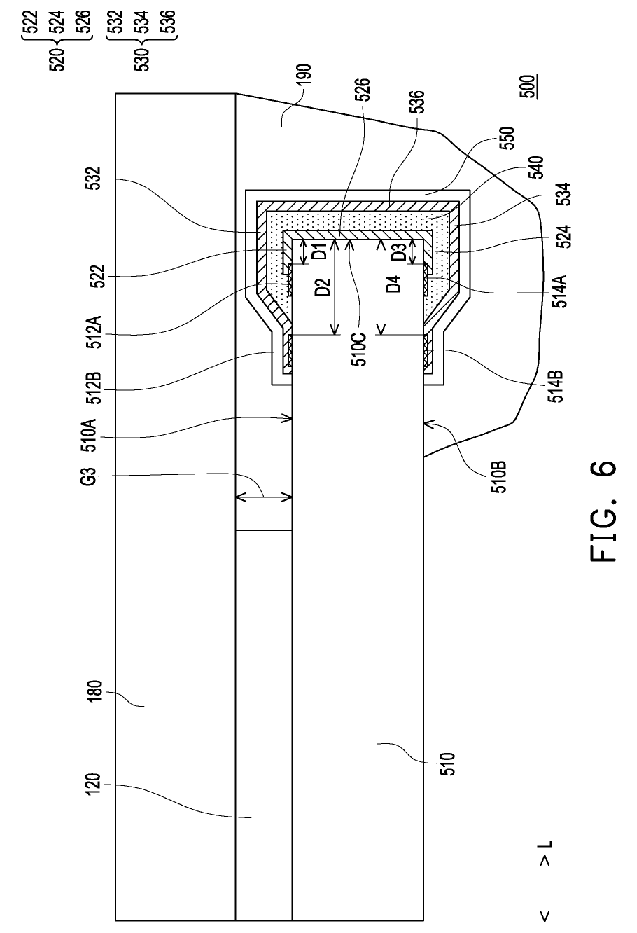

FIG. 6 is a schematic diagram of the electronic paper display device according to an embodiment of the disclosure. In an electronic paper display device 500 in FIG. 6 and the electronic paper display device 100 in FIG. 2, the same reference numerals may represent the same or equivalently replaceable components. The electronic paper display device 500 in FIG. 6 includes, for example, the electronic paper display layer 120, the protective plate 180, and the sealing adhesive 190 already described in FIG. 2. In addition, the electronic paper display device 500 in FIG. 6 further includes an electronic paper supporting structure 510, a first edge conductive pattern 520, a second edge conductive pattern 530, an edge isolation pattern 540, and an edge protection pattern 550. The electronic paper supporting structure 510 has a display surface 510A, a bonding surface 510B, and a side connection surface 510C connecting the display surface 510A and the bonding surface 510B. The electronic paper display layer 120 is disposed on the display surface 510A of the electronic paper supporting structure 510. The first edge conductive pattern 520 is disposed on the side connection surface 510C of the electronic paper supporting structure 510 and is disposed along the display surface 510A, the side connection surface 510C, and the bonding surface 510B. The edge isolation pattern 540 is disposed along the display surface 510A, the side connection surface 510C, and the bonding surface 510B and covers the first edge conductive pattern 520. Thus, the first edge conductive pattern 520 is sandwiched between the edge isolation pattern 540 and the electronic paper supporting structure 510. The edge isolation pattern 540 extends beyond the first edge conductive pattern 520 toward the electronic paper display layer 120 in the lateral direction L to partially contact the display surface 510A and the bonding surface 510B. The second edge conductive pattern 530 is disposed along the display surface 510A, the side connection surface 510C, and the bonding surface 510B. The second edge conductive pattern 530 extends beyond the edge isolation pattern 540 toward the electronic paper display layer 120 in the lateral direction L to partially contact the display surface 510A and the bonding surface 510B. The edge protection pattern 550 is disposed along the display surface 510A, the side connection surface 510C, and the bonding surface 510B and covers the second edge conductive pattern 530. In this embodiment, "lateral" may be understood as the direction extending from the side connection surface 510C toward the electronic paper display layer 120.

The electronic paper supporting structure 510 includes a first display surface pad 512A, a second display surface pad 512B, a first bonding surface pad 514A, and a second bonding surface pad 514B. The first display surface pad 512A and the second display surface pad 512B are exposed on the display surface 510A, while the first bonding surface pad 514A and the second bonding surface pad 514B are exposed on the bonding surface 510B. The first edge conductive pattern 520 electrically connects the first display surface pad 512A and the first bonding surface pad 514A. The second edge conductive pattern 530 electrically connects the second display surface pad 512B and the second bonding surface pad 514B. As a result, the first edge conductive pattern 520 and the second edge conductive pattern 530 may realize electrical connection paths on opposite sides of the electronic paper supporting structure 510 without the need to process the electronic paper supporting structure 510 and without additional external wires or circuit boards.

In some embodiments, the first edge conductive pattern 520, the second edge conductive pattern 530, the edge isolation pattern 540, and the edge protection pattern 550 may be manufactured on the electronic paper supporting structure 510 by printing, spraying, or other methods. The first edge conductive pattern 520, the second edge conductive pattern 530, the edge isolation pattern 540, and the edge protection pattern 550 all have non-planar structures and may be continuously disposed on the display surface 510A, the side connection surface 510C, and the bonding surface 510B of the electronic paper supporting structure 510. The first edge conductive pattern 520, the edge isolation pattern 540, the second edge conductive pattern 530, and the edge protection pattern 550 are adjoined and attached to the display surface 510A, the side connection surface 510C, and the bonding surface 510B, and thus the three-dimensional transmission structure formed by the first edge conductive pattern 520, the edge isolation pattern 540, the second edge conductive pattern 530, and the edge protection pattern 550 requires merely a narrow space. For example, the border width of the electronic paper display device 500 in the lateral direction L may be reduced to approximately 1.9mm (millimeters).

The first edge conductive pattern 520 is closely attached to the display surface 510A, the side connection surface 510C, and the bonding surface 510B of the electronic paper supporting structure 510 to be connected to the first display surface pad 512A and the first bonding surface pad 514A, while directly contacting the display surface 510A, the side connection surface 510C, and the bonding surface 510B of the electronic paper supporting structure 510. The first edge conductive pattern 520 may include a first portion 522, a second portion 524, and a third portion 526. The first portion 522 is disposed on the display surface 510A of the electronic paper supporting structure 510, the second portion 524 is disposed on the bonding surface 510B of the electronic paper supporting structure 510, and the third portion 526 extends between the first portion 522 and the second portion 524. The third portion 526 of the first edge conductive pattern 520 may contact the side connection surface 510C of the electronic paper supporting structure 510. Furthermore, the first portion 522 and the second portion 524 of the first edge conductive pattern 520 both extend in the same direction (toward the electronic paper display layer 120) from the third portion 526 in the lateral direction L, forming a structure that is shaped approximately similar to the letter "C" in the side view.

In some embodiments, the electronic paper display device 500 may include multiple first edge conductive patterns 520 sequentially disposed along the side connection surface 510C. In some embodiments, the edge isolation pattern 540 may extend between the multiple first edge conductive patterns 520. The edge isolation pattern 540 covers the first edge conductive pattern 520 so that the first edge conductive pattern 520 is disposed between the edge isolation pattern 540 and the side connection surface 510C of the electronic paper supporting structure 510. The extension length of the edge isolation pattern 540 in the lateral direction L may exceed the first display surface pad 512A and the first bonding surface pad 514A, so as to completely cover the first edge conductive pattern 520, the first display surface pad 512A, and the first bonding surface pad 514A.

The second edge conductive pattern 530 is disposed on the electronic paper supporting structure 510 and the edge isolation pattern 540. Specifically, the edge isolation pattern 540 is located between the second edge conductive pattern 530 and the side connection surface 510C of the electronic paper supporting structure 510. The second edge conductive pattern 530 may include a first portion 532, a second portion 534, and a third portion 536. The first portion 532 extends on the display surface 510A of the electronic paper supporting structure 510 from the edge isolation pattern 540 toward the electronic paper display layer 120 to contact the second display surface pad 512B. The second portion 534 extends on the bonding surface 510B of the electronic paper supporting structure 510 from the edge isolation pattern 540 toward the electronic paper display layer 120 to contact the second bonding surface pad 514B. The third portion 536 is entirely located on the edge isolation pattern 540 and extends between the first portion 532 and the second portion 534. The third portion 536 of the second edge conductive pattern 530 may be isolated from the side connection surface 510C of the electronic paper supporting structure 510 through the edge isolation pattern 540. That is, the edge isolation pattern 540 is located between the second edge conductive pattern 530 and the side connection surface 510C of the electronic paper supporting structure 510. Furthermore, the first portion 532 and the second portion 534 of the second edge conductive pattern 530 both extend in the same direction (toward the electronic paper display layer 120) from the third portion 536 in the lateral direction L, forming a structure that is shaped approximately similar to the letter "C" in the side view.

In some embodiments, a lateral distance D1 between the first display surface pad 512A and the side connection surface 510C is smaller than a lateral distance D2 between the second display surface pad 512B and the side connection surface 510C. Therefore, the first portion 532 of the second edge conductive pattern 530 extends laterally on the display surface 510A beyond the first edge conductive pattern 520 to contact the second display surface pad 512B. Similarly, a lateral distance D3 between the first bonding surface pad 514A and the side connection surface 510C is smaller than a lateral distance D4 between the second bonding surface pad 514B and the side connection surface 510C. Therefore, the second portion 534 of the second edge conductive pattern 530 also extends laterally on the bonding surface 510B beyond the first edge conductive pattern 520 to contact the second bonding surface pad 514B.

The edge protection pattern 550 covers the second edge conductive pattern 530 so that the second edge conductive pattern 530 is disposed between the edge isolation pattern 540 and the edge protection pattern 550. The extension length of the edge protection pattern 550 in the lateral direction L may exceed the second display surface pad 512B and the second bonding surface pad 514B, so as to completely cover the second edge conductive pattern 530, the second display surface pad 512B, and the second bonding surface pad 514B. The sealing adhesive 190 may encapsulate the edge protection pattern 550 and fill a gap G3 between the electronic paper supporting structure 510 and the protective plate 180.

The electronic paper display device 500 may further include a driving circuit chip (not shown, but reference may be made to the description of FIG. 1 to FIG. 5) bonded to the bonding surface 510B of the electronic paper supporting structure 510 and a connection circuit board (not shown, but reference may be made to the description of FIG. 1 to FIG. 5) such as a flexible circuit board or similar. In some embodiments, the driving circuit chip may be packaged on the flexible circuit board, and the flexible circuit board may be bonded to the bonding surface 510B. In some embodiments, the electronic paper supporting structure 510 may include a separate pixel array substrate, which is formed by a substrate, a pixel circuit array, and related conductive lines. For example, the electronic paper supporting structure 510 may be the pixel array substrate 110 shown in FIG. 2, and further include the first bonding surface pad 514A and the second bonding surface pad 514B disposed on the bonding surface 510B. In some embodiments, the electronic paper supporting structure 510 may include multiple bonded layers. For example, the electronic paper supporting structure 510 may include a multilayer structure formed by the pixel array substrate 110, the adhesive layer 140, and the driving circuit carrier 130 shown in FIG. 5. In this way, the first bonding surface pad 514A and the second bonding surface pad 514B may be the pads exposed on the bonding surface 130A of the driving circuit carrier 130. In addition, the side connection surface 510C may be understood as the side connection surface 400A in FIG. 5.

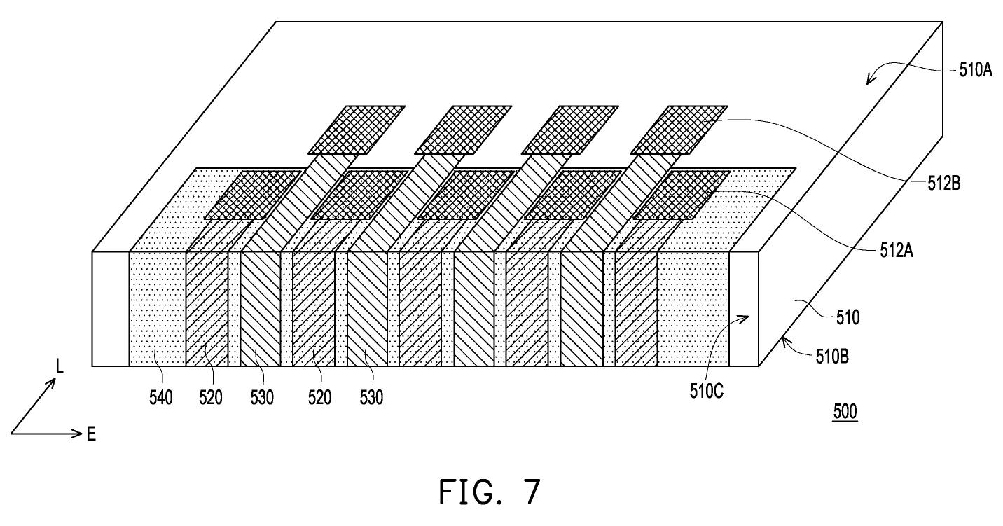

FIG. 7 is a partial perspective view of the electronic paper display device in FIG. 6. For convenience of description, FIG. 7 merely shows the electronic paper supporting structure 510, the first edge conductive pattern 520, the second edge conductive pattern 530, and the edge isolation pattern 540. The electronic paper display device 500 shown in FIG. 7 may include multiple first edge conductive patterns 520 and multiple second edge conductive patterns 530. The first edge conductive patterns 520 and the second edge conductive patterns 530 are, for example, alternately disposed along an extension direction E of the side connection surface 510C of the electronic paper supporting structure 510. In some embodiments, the areas of the first edge conductive pattern 520 and the second edge conductive pattern 530 may not completely overlap or may even not overlap at all. The first edge conductive pattern 520 is located between the edge isolation pattern 540 and the side connection surface 510C of the electronic paper supporting structure 510, and the edge isolation pattern 540 is, for example, located between the second edge conductive pattern 530 and the side connection surface 510C of the electronic paper supporting structure 510. The first edge conductive pattern 520 and the second edge conductive pattern 530 both extend inward from the side connection surface 510C along the lateral direction L (for example, extending toward the electronic paper display layer 120 shown in FIG. 6) on the display surface 510A (or on the bonding surface 510B). Additionally, as shown in FIG. 7, the first display surface pad 512A connected to the first edge conductive pattern 520 and the second display surface pad 512B connected to the second edge conductive pattern 530 are also alternately disposed along the extension direction E of the side connection surface 510C. The second display surface pad 512B may be farther from the side connection surface 510C than the first display surface pad 512A.

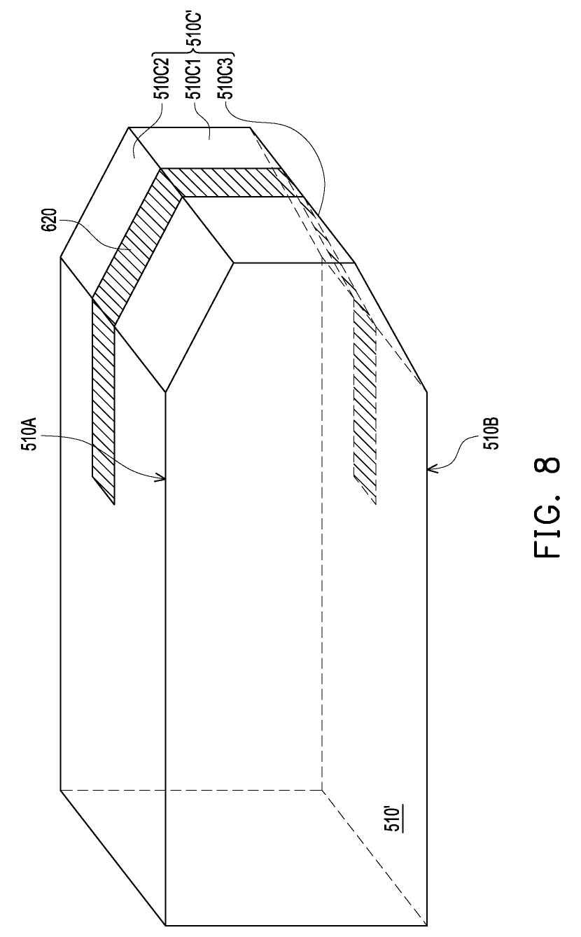

FIG. 8 is another embodiment of an electronic paper supporting structure in the electronic paper display device in FIG. 6. In this embodiment, a side connection surface 510C' of the electronic paper supporting structure 510' may be divided into multiple sections, for example, including a side edge section 510C1 and two chamfer sections 510C2 and 510C3. The two chamfer sections 510C2 and 510C3 extend between the side edge section 510C1 and the display surface 510A, and between the side edge section 510C1 and the bonding surface 510B, respectively. In addition, the two chamfer sections 510C2 and 510C3 may be inclined with respect to the side edge section 510C1. At this time, the angle between the chamfer section 510C2 and the side edge section 510C1 is obtuse, the angle between the chamfer section 510C3 and the side edge section 510C1 is obtuse, the angle between the chamfer section 510C2 and the display surface 510A is obtuse, and the angle between the chamfer section 510C3 and the bonding surface 510B is obtuse. In this way, when the first edge conductive pattern 620 is manufactured by printing or coating, the operation only experiences gentler transitions, which helps improve manufacturing yield.

In summary, the electronic paper display device of the embodiments of the disclosure has the edge conductive patterns manufactured by precision printing or coating methods, which may achieve a narrow frame structural design.

What is claimed is:

1. An electronic paper display device, comprising:
an electronic paper supporting structure having a display surface, a bonding surface, and a side connection surface, wherein the display surface and the bonding surface are opposite to each other, the side connection surface is connected between the display surface and the bonding surface, and the electronic paper supporting structure comprises a display surface pad exposed on the display surface and a bonding surface pad exposed on the bonding surface;
an electronic paper display layer disposed on the display surface of the electronic paper supporting structure; and
an edge conductive pattern physically contacting the electronic paper supporting structure, wherein the edge conductive pattern physically contacts the side connection surface and continuously extends on the side connection surface between the display surface and the bonding surface to contact the display surface pad and the bonding surface pad.

2. The electronic paper display device as claimed in claim 1, wherein the edge conductive pattern comprises a first portion, a second portion and a third portion, the first portion is disposed on the display surface, the second portion is disposed on the bonding surface, and the third portion is disposed on the side connection surface.

3. The electronic paper display device as claimed in claim 2, wherein the first portion and the second portion extend in same direction from the third portion in a lateral direction.

4. The electronic paper display device as claimed in claim 2, wherein the first portion and the second portion extend in opposite directions from the third portion in a lateral direction.

5. The electronic paper display device as claimed in claim 1, further comprising an edge isolation pattern and another edge conductive pattern, wherein the edge isolation pattern covers the edge conductive pattern, the another edge conductive pattern is disposed on the edge isolation pattern, and the edge conductive pattern and the another edge conductive pattern are alternately disposed along an extension direction of the side connection surface of the electronic paper supporting structure.

6. The electronic paper display device as claimed in claim 5, wherein the edge conductive pattern, the edge isolation pattern, and the another edge conductive pattern are continuously disposed conforming to the display surface, the side connection surface, and the bonding surface respectively.

7. The electronic paper display device as claimed in claim 5, wherein the electronic paper supporting structure further comprises another display surface pad exposed on the display surface, and the another edge conductive pattern contacts the another display surface pad.

8. The electronic paper display device as claimed in claim 7, wherein a lateral distance between the display surface pad and the side connection surface is smaller than a lateral distance between the another display surface pad and the side connection surface.

9. The electronic paper display device as claimed in claim 5, wherein the electronic paper supporting structure further comprises another bonding surface pad exposed on the bonding surface, and the another edge conductive pattern contacts the another bonding surface pad.

10. The electronic paper display device as claimed in claim 9, wherein a lateral distance between the bonding surface pad and the side connection surface is smaller than a lateral distance between the another bonding surface pad and the side connection surface.

11. The electronic paper display device as claimed in claim 1, wherein the electronic paper supporting structure comprises a pixel array substrate, and the pixel array substrate has the display surface and comprises the display surface pad.

12. The electronic paper display device as claimed in claim 11, wherein the electronic paper supporting structure further comprises a driving circuit carrier and an adhesive layer, the adhesive layer attaches the driving circuit carrier to the pixel array substrate, and the driving circuit carrier has the bonding surface and comprises the bonding surface pad.

13. The electronic paper display device as claimed in claim 12, wherein the driving circuit carrier protrudes outward with respect to the pixel array substrate.

14. The electronic paper display device as claimed in claim 12, wherein the electronic paper supporting structure further comprises an enhanced substrate attached to the driving circuit carrier.

15. The electronic paper display device as claimed in claim 12, wherein the bonding surface faces the pixel array substrate.

16. The electronic paper display device as claimed in claim 12, wherein the bonding surface faces away from the pixel array substrate.

17. The electronic paper display device as claimed in claim 12, wherein the side connection surface comprises a side wall of the pixel array substrate, a side wall of the driving circuit carrier, and a side wall of the adhesive layer.

18. The electronic paper display device as claimed in claim 11, wherein the electronic paper supporting structure further comprises an enhanced substrate and an adhesive layer, and the enhanced substrate is attached to the pixel array substrate through the adhesive layer.

19. The electronic paper display device as claimed in claim 18, wherein the side connection surface comprises a side wall of the pixel array substrate, a side wall of the enhanced substrate, and a side wall of the adhesive layer.

20. The electronic paper display device as claimed in claim 1, wherein the side connection surface of the electronic paper supporting structure comprises a side edge section and two chamfer sections, the two chamfer sections respectively extend between the side edge section and the display surface and between the side edge section and the bonding surface, and the two chamfer sections are inclined with respect to the side edge section.
